(19) United States
(12) Patent Application Publication
(10) Pub. No.: US 2004/0240237 A1
(43) Pub. Date: Dec. 2, 2004

(54) Power converter

(75) Inventors: Hideo Okayama, Tokyo (JP); Yasuhito Shimomura, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/823,645

(22) Filed: Apr. 14, 2004

(30) Foreign Application Priority Data
May 29, 2003 (JP) 2003-153003

(51) Int. Cl. H02J 1/02

(52) U.S. Cl. 363/39

(57) ABSTRACT

A power converter outputting a large current while reducing harmonics flowing into an AC power supply and an AC load. The power converter includes power units, each of which includes an input transformer having at least one primary winding connected with a polyphase AC power supply and at least one secondary winding, a polyphase self-excited rectifier circuit connected with the secondary winding, and a single-phase self-excited inverter circuit connected with the polyphase self-excited rectifier circuit through a DC link circuit to generate a single-phase output. One of single-phase outputs of each power unit is connected with one of single-phase outputs of another power unit so that the outputs of the power units are cascaded in series with one another, with serially connected outputs of the power units connected to a polyphase AC load.

### BACKGROUND OF THE INVENTION

1. Field of the Invention

The present invention relates to a power converter for performing power conversion between a polyphase AC power supply and a polyphase AC load, and more particularly to such a power converter capable of generating a multilevel input voltage and a multilevel output voltage.

2. Description of the Related Art

A known power converter has a single polyphase input transformer with a primary winding and a plurality of secondary windings which are out of phase with the primary winding. The primary winding of the polyphase input transformer is connected with a polyphase AC power supply so as to receive multilevel power therefrom. In addition, the respective secondary windings of the polyphase input transformer are connected with power cells, respectively, each of which includes a diode rectifier circuit comprising six diodes, a filter circuit, and a single-phase inverter circuit. Each power cell has input terminals connected with the diode rectifier circuit, and output terminals connected with the single-phase inverter circuit. The output terminals of the power cell are connected with one another in a cascade series, with the power cell output terminals at opposite ends thereof being connected with one neutral point and each phase of a polyphase AC load, respectively (for instance, see a first patent document: U.S. Pat. No. 5,625,545 (FIG. 1 and FIG. 4)).

In such a known power converter, in order to reduce harmonics included in the primary winding of the polyphase input transformer, the polyphase input transformer uses the plurality of secondary windings so as to make the output phases thereof different from one another. Therefore, there is a problem that the structure of the polyphase input transformer becomes complicated.

Moreover, with the known power converter, a high rated voltage of the polyphase AC load can be accommodated by increasing the number of power cells connected in the cascade series. However, the number of the secondary windings of the polyphase input transformer increases in accordance with the increasing number of power cells, so the structure of the polyphase input transformer becomes further complicated.

Further, in a polyphase input transformer having a large power capacity, electric current passing through primary windings thereof becomes large, and hence it becomes difficult to consolidate the primary windings into a single piece.

Furthermore, in known power converters, polyphase transformers are generally designed individually based on the capacities of the power converters and hence they can be designed relatively compact and small-sized, but it is necessary to design the polyphase transformers in accordance with varying capacities of the transformers as required in individual cases.

Still further, in the above-mentioned known power converter, it is necessary to increase the number of power cells in order to enlarge the power capacity of the power converter, and hence the number of cables connecting between the polyphase transformer and the power cells also increases, thus pushing up the construction cost of the power converter accordingly, too.

In addition, it will readily be considered by those skilled in the art that in case where the rated current of the AC current load to be driven by the above-mentioned known power converter becomes large, the plurality of diodes, which constitute the diode rectifier circuit of each power cell, are connected in parallel with one another, and at the same time a plurality of self-arc-extinguishing type semiconductor devices and a plurality of diodes which together constitute the single-phase inverter circuit, are also connected in parallel with one another so as to to accommodate such a large current. In this case, however, to accommodate the capacities of a variety of AC loads, there arises a need to provide a plurality of power cells with the number of parallel connections of their components being different from one another in a variety of manners. When bearing the standardization of the power cells in mind, this requires that a plurality of power cells with a different number of parallel connections between self-arc-extinguishing type semiconductor devices and diodes are prepared as standard cells, thus resulting in increased manufacturing cost.

### SUMMARY OF THE INVENTION

Accordingly, the object of the present invention is to provide a power converter which includes a polyphase transformer of a simple structure and a plurality of power cells having the same specifications, and which is capable of outputting a large current while reducing harmonics flowing into an AC power supply and an AC load.

In order to achieve the above object, the present invention resides in a power converter including a plurality of power units, each of which includes: an input transformer group including at least one input transformer having at least one primary winding connected with a first polyphase AC power supply and at least one secondary winding; a polyphase self-excited rectifier circuit connected with the secondary winding; and a single-phase self-excited inverter circuit connected with the polyphase self-excited rectifier circuit through a DC link circuit to generate a single-phase power output. Adjacent ones of the power units in each phase are sequentially cascaded in series with one another, with one of the power units at one end of the cascade connection being connected with a polyphase AC load, another one of the power units at the other end of the cascade connection being connected with a neutral point, whereby electric power is input from the first polyphase AC power supply to the power units and output therefrom to the polyphase AC load, or the electric power of the polyphase AC load is regenerated to the first polyphase AC power supply.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a view showing the circuit configuration of a power converter according to a first embodiment of the present invention.

FIG. 2 is a view showing the circuit configuration of a power unit applied to the power converter of FIG. 1.

FIG. 3 is a view showing the circuit configuration of a power cell applie d d to the power converter of FIG. 1.

FIG. 4 is a view showing the detailed circuit configuration of the power cell of FIG. 3.

FIG. 5 is a view showing a phase module applied to the power cell of FIG. 4.

FIG. 6 is a view showing the circuit configuration of a power converter according to a second embodiment of the present invention.

FIG. 7 is a constructional view of a power unit used for a power converter according to a third embodiment of the present invention.

FIG. 8 is a view showing the detailed circuit configuration of a power cell of a power converter according to a fourth embodiment of the present invention.

FIG. 9 is a circuit configuration diagram of a phase module of the power cell of FIG. 8.

FIG. 10 is a view showing the circuit configuration of the power converter of FIG. 8.

FIG. 11 is a view showing the circuit configuration of a power cell of a power converter according to a fifth embodiment of the present invention.

FIG. 12 is a circuit configuration diagram of a phase module of the power cell of FIG. 11.

FIG. 13 is a view showing the circuit configuration of the power converter of FIG. 11.

FIG. 14 is a view showing a modification of the circuit configuration of the power converter of FIG. 11.

FIG. 15 is a layout view of a power cell of a power converter according to a sixth embodiment of the present invention.

FIG. 16 is another layout view of the power cell of the power converter according to the sixth embodiment of the present invention.

FIG. 17 is a view showing the circuit configuration of a power converter according to a seventh embodiment of the present invention.

FIG. 18 is a view showing an electric current bypass route of the power cell of FIG. 4.

FIG. 19 is a view showing another electric current bypass route of the power cell of FIG. 4.

FIG. 20 is a view showing an electric current bypass route of the power cell of FIG. 8.

FIG. 21 is a view showing another electric current bypass route of the power cell of FIG. 8.

### DESCRIPTION OF THE PREFERRED EMBODIMENTS

Now, preferred embodiments of the present invention will be described in detail while referring to the accompanying drawings. Embodiment 1.

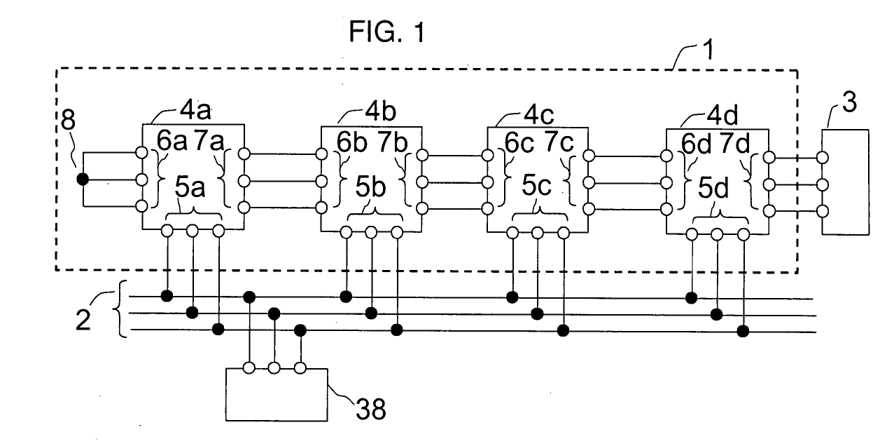

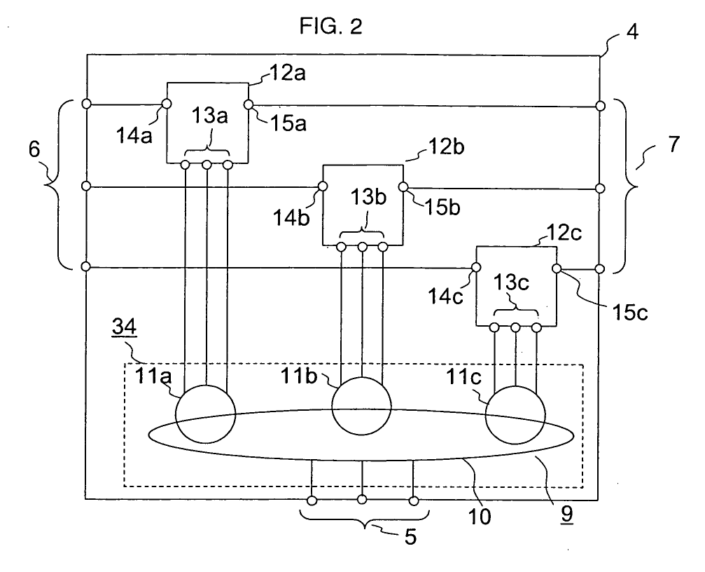

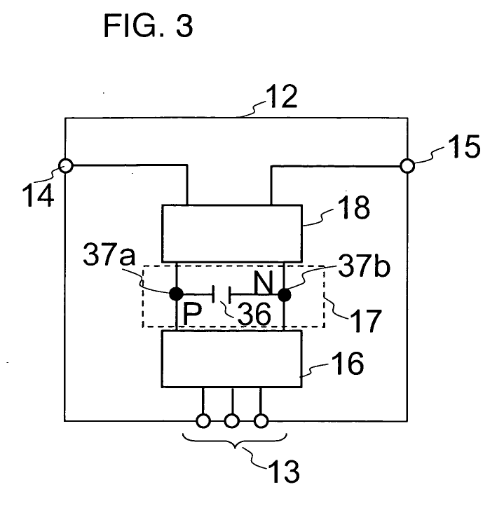

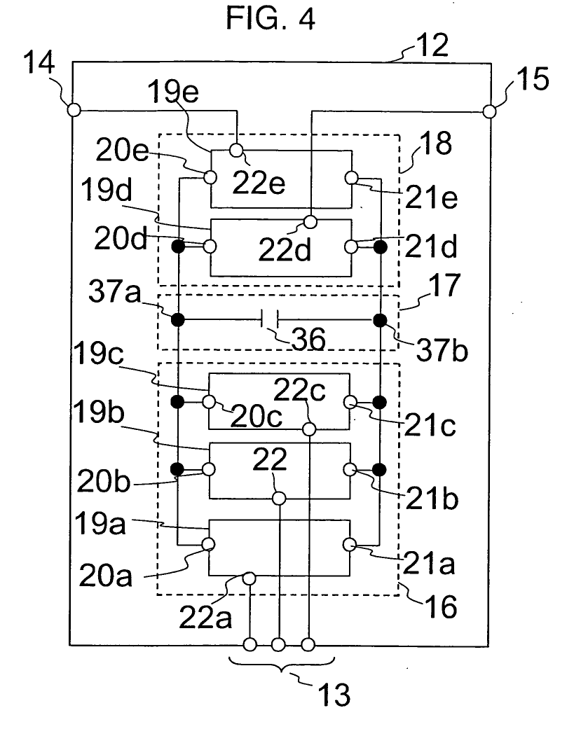

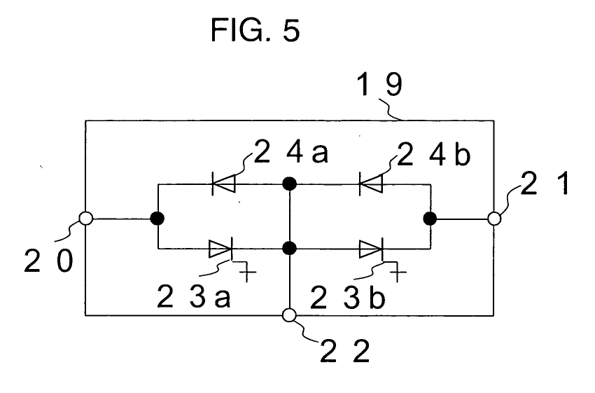

FIG. 1 is a view that shows the circuit configuration of a power converter according to a first embodiment of the present invention, wherein the power converter includes four power units. FIG. 2 shows the circuit configuration of each of the power units constituting the power converter of FIG. 1. FIG. 3 shows the circuit configuration of a power cell of the power unit of FIG. 2. FIG. 4 shows the detailed circuit configuration of the power cell of FIG. 3. FIG. 5 shows the circuit configuration of a phase module of FIG. 4.

As shown in FIG. 1, the power converter, generally designated at reference numeral 1, serves to connect between a polyphase AC power supply 2 and a polyphase AC load 3 in such a manner that electric power is supplied from a polyphase AC power supply 2 to a polyphase AC load 3, or electric power is regenerated from the polyphase AC load 3 to the polyphase AC power supply 2. In the following explanation, the polyphase power converter comprising a three-phase power converter will be described while assuming that the number of phases is three, however, the number of phases is not limited to three but may be any other than this as required by the polyphase AC load 3. Also, the polyphase AC load 3 comprises a three-phase motor for driving a compressor in this embodiment, but it may be any polyphase electric device.

The three-phase power converter 1 includes four power units 4a, 4b, 4c, 4d which are connected in a cascade series with one another and which have all the same circuit configuration. The power units 4a, 4b, 4c, 4d have first input terminal groups 5a, 5b, 5c, 5d, respectively, which are respectively connected with the polyphase AC power supply 2, which comprises a three-phase AC power supply in this embodiment. The first or initial power unit 4a has a first output terminal group 6a connected with a neutral point 8. The fourth or last power unit 4d has a second output terminal group 7d comprising three output terminals connected with corresponding three-phase terminals of the polyphase AC load 3. Also, the power unit 4a has a second output terminal group 7a connected with a first output terminal group 6b of the second power unit 4b, which has a second output terminal group 7b in turn connected with a first output terminal group 6c of the third power unit 4c, which has a second output terminal group 7c in turn connected with a first output terminal group 6d of the fourth or last power unit 4d.

As shown in FIG. 1, the output voltages of the power units 4a, 4b, 4c, 4d are output to the first output terminal groups 6a, 6b, 6c, 6d and to the second output terminal groups 7a, 7b, 7c, 7d. Here, note that the rated values of the output voltages are assumed to be 3.3 kV. When electric power is supplied to the polyphase AC load 3 of a voltage of 13.2 kV, all the four power units 4a, 4b, 4c, 4d are needed, and hence the three-phase power converter 1 includes the four power units 4a, 4b, 4c, 4d. In this case, at least 12 cables are necessary for connecting the polyphase AC power supply 2 in the form of a three-phase power supply and the power units 4a, 4b, 4c, 4d in the form of three-phase power units with one another.

Here, note that an item 38 in FIG. 1 is not related to this first embodiment but to an eighth embodiment which will be described later.

As shown in FIG. 2, each power unit, representatively designated at reference numeral 4, includes a single input transformer 9 having a single primary winding 10 and three secondary windings 11a, 11b, 11c, and three power cells 12a, 12b, 12c. The polyphase AC load 3 comprises a three-phase motor that requires three single-phase power outputs. The primary winding 10 of the input transformer 9 is connected with a first input terminal group 5, and the secondary windings 11a, 11b, 11c of the input transformer 9 are connected with first input terminal groups 13a, 13b, 13c of the power cells 12a, 12b, 12c, respectively. An input transformer group 34 of the power unit 4 of FIG. 2 comprises the single input transformer 9.

The first power cell 12a has a first output terminal 14a connected with one of the terminals of a first output terminal group 6 of the power unit 4, and a second output terminal 15a connected with one of the terminals of a second output terminal group 7 of the power unit 4. Also, the other power cells 12b, 12c of the power unit 4 each have a first output terminal 14b or 14c and a second output terminal 15b or 15c connected with the first output terminal group 6 and the second output terminal group 7, respectively, as in the power cell 12a. At least 36 cables are required for connecting between the secondary windings 11a, 1b, 1c of the input transformers 9 and the respective power cells 12a, 12b, 12c of the four power units 4a, 4b, 4c, 4d.

As shown in FIG. 3, a power cell, representatively designated at reference numeral 12, includes a three-phase self-excited rectifier circuit 16, a DC link circuit 17, and a single-phase self-excited inverter circuit 18. The three-phase self-excited rectifier circuit 16 rectifies a voltage input to a first input terminal group 13, and adjusts the input power factor thereof so that a voltage across a filter capacitor 36 of the DC link circuit 17 can be properly controlled. In addition, the single-phase self-excited inverter circuit 18 outputs in a single-phase the voltage of the DC link circuit 17 to the first output terminal 14 and the second output terminal 15 for a prescribed period of time.

As shown in detail in FIG. 4, the polyphase self-excited rectifier circuit 16 of the power cell 12 includes three phase modules 19a, 19b, 19c, and the single-phase self-excited inverter circuit 18 includes two phase modules 19d, 19e, all the phase modules being of the same circuit configuration. Here, note that with respect to the power units and the power cells, the definition of the input and output is based on the case where electric power is supplied from the polyphase AC power supply to the polyphase AC load. Conversely, with respect to the phase modules, it is defined that the direction in which direct current is converted into alternating current is defined as an input direction.

As concretely shown in FIG. 5, a phase module, representatively designated at reference numeral 19, includes a pair of self-arc-extinguishing type semiconductor devices 23a, 23b connected in series with each other and a pair of serially connected diodes 24a, 24b which are connected in antiparallel with the serially connected semiconductor devices 23a, 23b. The phase module 19 has a first input terminal 20 connected with a positive terminal 37a of the DC link circuit 17, and a second input terminal 21 connected with a negative terminal 37b thereof. Further, as shown in FIG. 4, the phase modules 19a, 19b, 19c each have a first output terminal 22a, 22b, 22c, respectively, connected with the first input terminal group 13, whereas the phase module 19d has a first output terminal 22d connected with the second output terminal 15, and the phase module 19e has a first output terminal 22e connected with the first output terminal 14.

Such a three-phase power converter 1 is able to control the power factor of the input transformer 9, i.e., the phase of current flowing through the secondary windings 11 of the input transformer 9 with respect to the voltage of the first input terminal group 5 by controlling to turn on and off the self-arc-extinguishing type semiconductor devices 23a, 23b of the phase modules 19a, 19b, 19c of the power cell 12a in FIG. 2.

In addition, it is possible to suppress the leakage of harmonics to the primary winding 10 of the input transformer 9. As a result, the phases of electric currents flowing into the first input terminal groups 5a, 5b, 5c, 5d with respect to the voltage of the polyphase AC power supply 2, i.e., the power factor, can be controlled so that harmonics flowing into the polyphase AC power supply 2 can be suppressed.

In addition, by controlling to turn on and off the self-arc-extinguishing type semiconductor devices 23a, 23b of the phase modules 19a-19e constituting the power cells 12a, 12b, 12c, voltages are output from the power cells 12a, 12b, 12c to the first output terminal group 6 and the second output terminal group 7. Thus, a voltage corresponding to the sum of voltages between the first respective output terminal groups 6a-6d and the second respective output terminal groups 7a-7d of the power units 4a, 4b, 4c, 4d can be applied to the polyphase AC load 3.

The number of switchings of the diode rectifier circuit when diode rectifiers are used instead of the three-phase self-excited rectifier circuit 16 is fixed to six times or so, and the phase of switching is fixed, too. On the other hand, in the three-phase self-excited rectifier circuit 16, the number of switchings of the self-arc-extinguishing type semiconductor devices 23a, 23b of the phase module 19 constituting the rectifier circuit 16 can be arbitrarily set to any value, i.e., even to a value exceeding six, and the phases of the switchings can be controlled, so that harmonics in the secondary windings 10 of the input transformer 9 of FIG. 2 can be suppressed more effectively.

Furthermore, when the voltage of the polyphase AC power supply 2 is supplied by a plurality of distributed and independent generators, the voltage of the polyphase AC power supply 2 becomes unstable, and in such a case, in a conventional diode rectifier circuit, a voltage variation of the polyphase AC power supply 2 influences the voltage of the filter capacitor 36 in the power cell 12. In the three-phase self-excited rectifier circuit 16 of the present invention, however, the voltage of the filter capacitor 36, being able to be controlled according to the voltage variation of the polyphase AC power supply 2, is free from any influence of such a voltage variation in the polyphase AC power supply 2.

Accordingly, when the voltage of the polyphase AC power supply 2 becomes low for instance, the three-phase power converter 1 is able to continue to operate due to the voltage boost operation of the three-phase self-excited rectifier circuit 16, whereas when the voltage of the polyphase AC power supply 2 becomes high, overvoltage of the filter capacitor 36 can be effectively prevented by the voltage lowering operation of the three-phase self-excited rectifier circuit 16.

Moreover, it is possible to prevent an overvoltage failure or damage to the self-arc-extinguishing type semiconductor devices 23a, 23b and the diodes 24a, 24b, together constituting the phase module 19.

Since such a power converter is constructed from a plurality of the same power units, a change in the required voltage of the polyphase AC load can be accommodated merely by changing the number of the power units used. Accordingly, there is no need to change the input transformer or the like, thus making it possible to enhance the reliability of the power converter.

In addition, by combining standard phase modules with each other, it is possible to construct the polyphase self-excited rectifier circuit and the single-phase self-excited inverter circuit, whereby the power converter can be provided at low cost.

Further, the number of switchings for the self-arc-extinguishing type semiconductor device can be set arbitrarily, and the phase of the switching thereof can be controlled, as a consequence of which harmonics can be suppressed more effectively.

Furthermore, the use of the power cells each having the self-excited rectifier circuit serves to stabilize the polyphase AC power supply.

Still further, since the input transformer has the plurality of secondary windings connected with the power cells, there is no need to use a phase-shifting winding transformer, thereby making it possible to reduce the cost of the input transformer.

Here, note that the number of power cells 4 can be arbitrarily selected according to the polyphase AC load 3.

Embodiment 2.

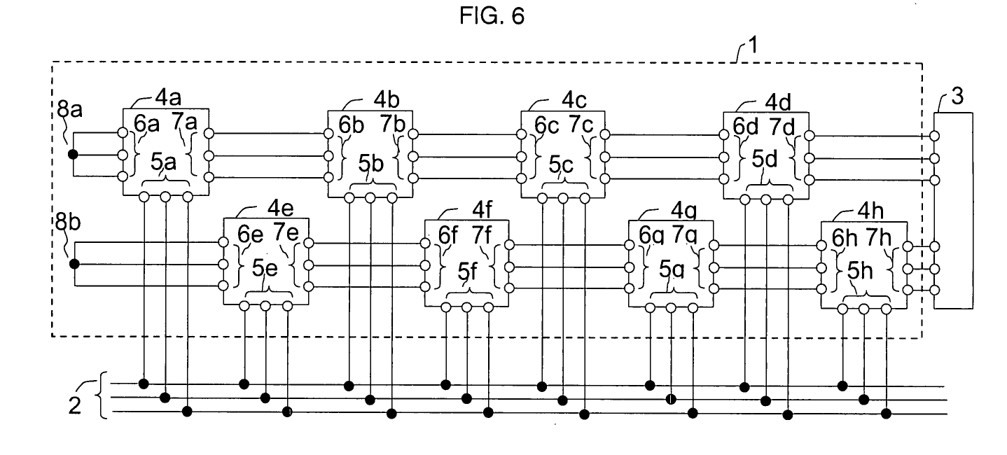

FIG. 6 is a view showing the circuit configuration of a power converter according to a second embodiment of the present invention, in which power units employed therein are similar to those of FIG. 2, thus omitting an explanation of similar portions.

As shown in the circuit configuration of FIG. 6, a three-phase power converter 1 of this second embodiment is suitable when a polyphase AC load 3 requires an electric current greater than that in the first embodiment. In the following, a description will be made with the polyphase AC load 3 being a three-phase multiple winding motor for instance.

Provision is made for a first and a second neutral point 8a, 8b, and with the first neutral point 8a thereof is serially connected a first output terminal group 6a of a first power unit 4a. A second output terminal group 7d of a fourth power unit 4d is connected in series with the polyphase AC load 3, and a first output terminal group 6e of a fifth power unit 4e is connected in series with the second neutral point 8b, and a second output terminal group 7h of an eighth power unit 4h is connected with the polyphase AC load 3. In addition, the first input terminal groups 5a-5h of the first through eighth power units 4a-4h are all connected with the polyphase AC power supply 2. Thus, by connecting power units with one another, which are of the same electric rating as that of the power units of FIG. 2 and are two times as many as the latter, as shown in FIG. 6, the current capacity of the three-phase power converter 1 equal to the double of that shown in FIG. 1 can be obtained. In this case, however, the voltage rating remains the same, i.e., 13.2 kV.

Such a power converter is constructed from a plurality of the same power units, and hence a change in the required voltage of the polyphase AC load can be accommodated merely by changing the number of the power units used. Therefore, there is no need to change the input transformer or the like, thus making it possible to enhance the reliability of the power converter.

Though the three-phase multiple winding motor has been assumed to be used herein, it will be clear that the three-phase power converter 1 of FIG. 6 does not limit the polyphase AC load 3.

Embodiment 3.

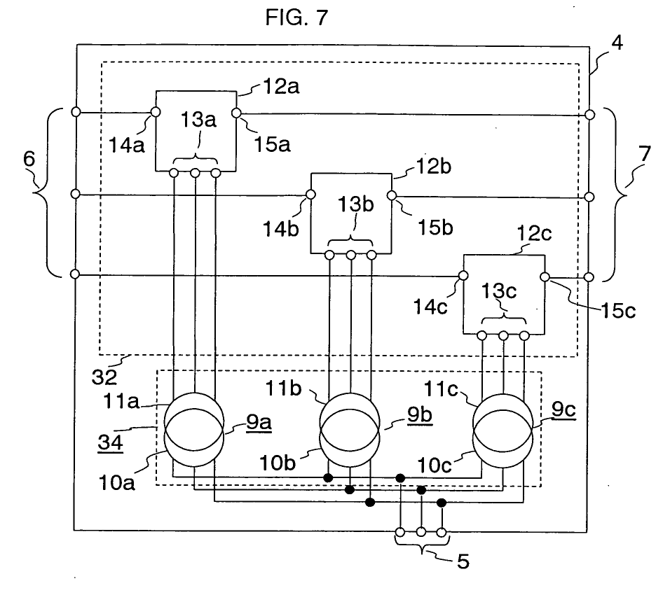

FIG. 7 shows the circuit configuration of a power unit 4 used in a power converter according to a third embodiment of the present invention. The power unit 4 in this embodiment differs from the one shown in FIG. 2 only in that each of power cells of the power unit has an input transformer, but it is similar in other respects, and an explanation of the similar portions is omitted.

An input transformer group 34 of the power unit 4 includes three input transformers 9a, 9b, 9c for three phases, respectively. These input transformers 9a, 9b, 9c correspond to power cells 12a, 12b, 12c, respectively. The input transformers 9a, 9b, 9c have single primary windings 10a, 10b, 10c and single secondary windings 11a, 11b, 11c, respectively. The primary windings 10a, 10b, 10c are connected with a first input terminal group 5 so as to receive electric power from an unillustrated polyphase AC power supply (confer the element 2 in FIG. 1). In addition, the secondary windings 11a, 11b, 11c of the input transformers 9a, 9b, 9c are connected with first input terminal groups 13a, 13b, 13c of the power cells 12a, 12b, 12c, respectively.

The first power cell 12a has a first output terminal 14a connected with one of the terminals of a first output terminal group 6 of the power unit 4, and a second output terminal 15a connected with one of the terminals of a second output terminal group 7 of the power unit 4. As for the other second and third power cells 12b, 12c, the configuration thereof is similar to that of the first power cell 12.

Such a power converter has an input transformer for each power cell and hence need not use a phase-shifting winding transformer. Therefore, it is possible to reduce not only the cost of the input transformer but also the electric power (electric current) passing therethrough, as a result of which the entire power converter can be reduced in size.

Embodiment 4.

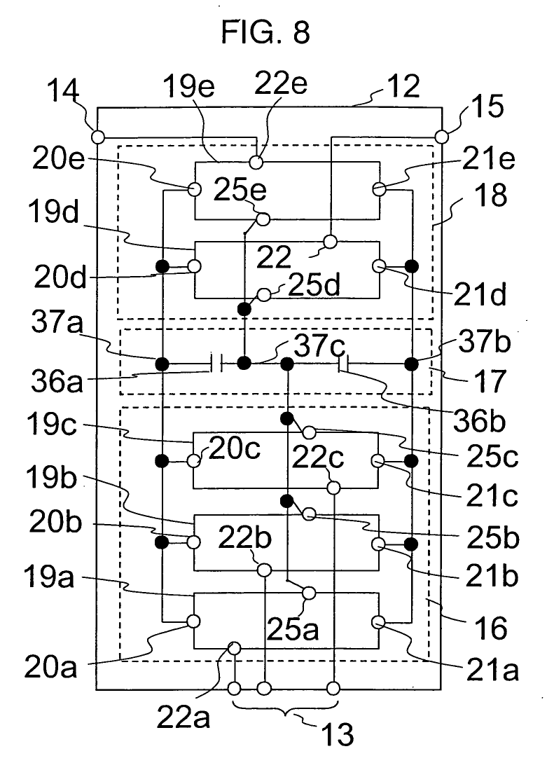

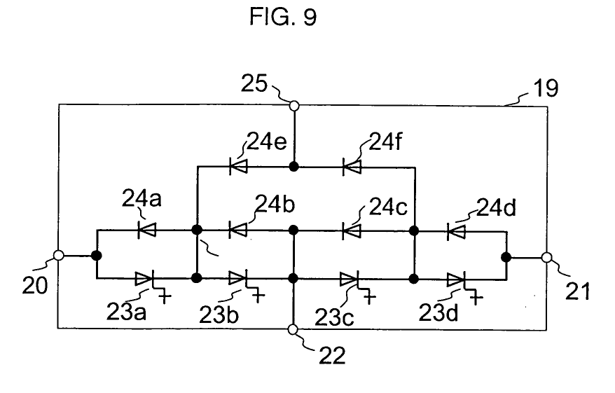

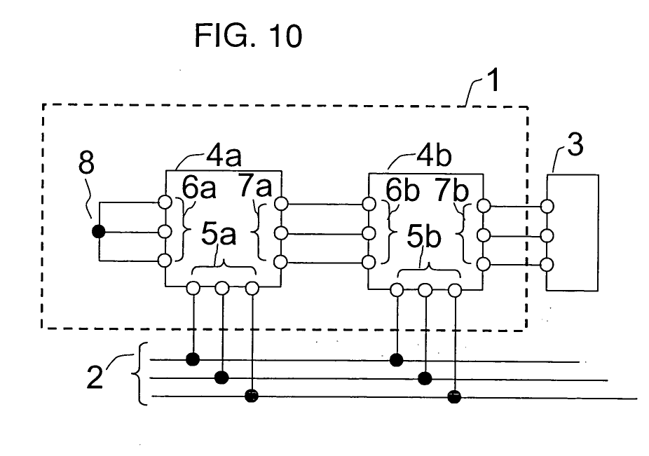

FIG. 8 shows the circuit configuration of a power cell of a power converter according to a fourth embodiment of the present invention. FIG. 9 shows the circuit configuration of a phase module used for the power cell of FIG. 8. FIG. 10 shows the circuit configuration of a power converter using the power unit of FIG. 8.

The three-phase power converter, generally designated at reference numeral 1, in the fourth embodiment of the present invention includes two power units 4a, 4b, each of which is different from the power unit 4 of FIG. 2 only in the configuration of a power cell, representatively designated at reference numeral 12, but the power converter 1 of this embodiment is similar in the other respects to that of FIG. 1, thus omitting an explanation of the similar portions.

As shown in FIG. 8, the power cell 12 includes a three-level three-phase self-excited rectifier circuit 16, a DC link circuit 17 comprising two filter capacitors 36a, 36b, and a three-level single-phase self-excited inverter circuit 18. The power cell 12 has a first output terminal 14, a second output terminal 15 and a first input terminal group 13 connected in the same manner as in the power cell 12 of FIG. 4.

As shown in FIG. 9, a phase module, representatively designated at reference numeral 1,9, includes a pair of self-arc-extinguishing type semiconductor devices 23a, 23b connected in series with each other, and a pair of serially connected diodes 24a-24d which are connected in antiparallel with diodes 24b, 24c connected in series with each other. By controlling the arc-extinguishing type semiconductor devices 23a-23d to turn them on and Off, the phase module 19 can select one of three different voltages at a first input terminal 20 (potential P), a third input terminal 25 (potential C) and at a second input terminal 21 (potential N) to output it at a first output terminal 22.

The electrical specifications of the self-arc-extinguishing type semiconductor devices 23a-23d and the diodes 24a-24f used in the phase module 19 of FIG. 9 are such that each of the power units 4a, 4b has an output voltage of 6.6 kV when the phase module 19 is the same as that of FIG. 5. When a voltage of 13.2 kV is to be supplied to a polyphase AC load 3, the number of power units as required becomes two as shown in FIG. 10, and two power units 4a, 4b are used to construct the three-phase power converter 1. Thus, the number of cables required for connecting the polyphase AC power supply 2 and the power units 4a, 4b with one another becomes six, and the number of cables required for connecting three secondary windings 11a-11c of an input transformer 9 and three power cells 12a-12c of each of the power units 4a, 4b (confer FIG. 2) becomes 18, and hence can be reduced to a substantial extent.

Such a power converter, using the power cells each provided with the three-level type self-excited rectifier circuit, is able to not only stabilize the polyphase AC power supply but also reduce harmonics flowing into the polyphase AC power supply. In addition, since the number of power cables used for electrical connections can be decreased, the construction cost of the power converter can also be reduced.

Moreover, it is possible to reduce not only the cost of the three-phase power converter 1 itself but also the construction cost thereof. In this case, it is preferred that the adjustment of voltage balance of the three-level type filter capacitors 36a, 36b be carried out by the three-level type three-phase self-excited rectifier circuit 16.

Furthermore, as an additional advantageous effect, it is possible to further reduce harmonics, which are included in the input of the three-level type three-phase self-excited rectifier circuit 16 and hence in the first input terminal group 5 and are flowing out into the polyphase AC power supply 2.

Here, it goes without saying that there is no need to limit the output voltage of each of the power units 4a, 4b to 6.6 kV.

Embodiment 5.

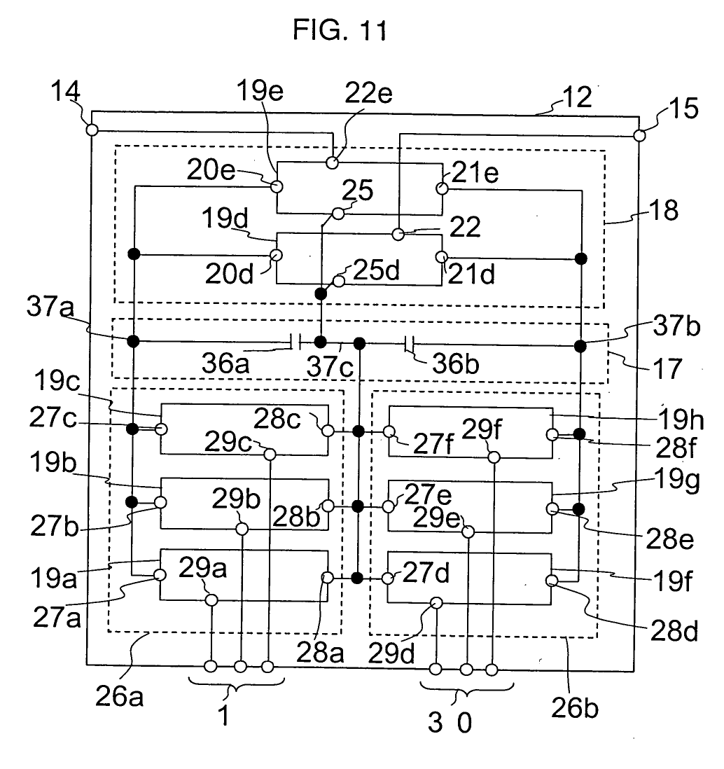

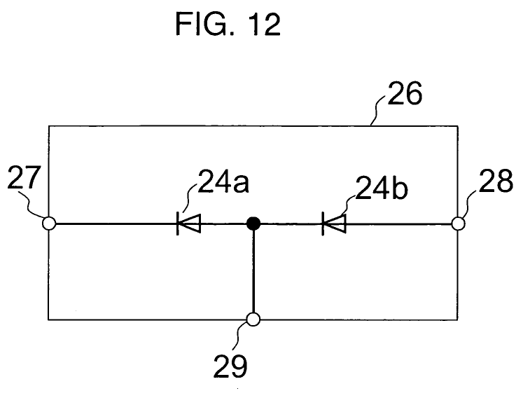

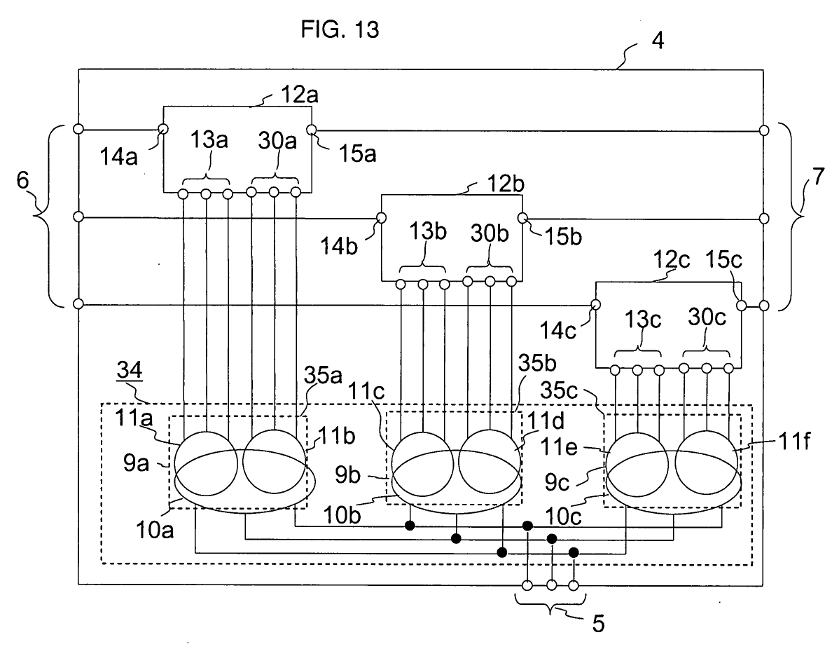

FIG. 11 shows the circuit configuration of a power cell for a power converter according to a fifth embodiment of the present invention. FIG. 12 shows the circuit configuration of a phase module of the power cell of FIG. 11. FIG. 13 shows the circuit configuration of a power converter using a plurality of power cells each shown in FIG. 11.

Although the power cell 12 shown in FIG. 8, including the three-level type three-phase self-excited rectifier circuit 16, can accommodate the bidirectional flows of electric power in a direction to supply power and in a reverse direction to regenerate power, a power converter with a unidirectional flow of electric power may be used according to the kind of the polyphase AC load 3. FIG. 11 shows the circuit configuration of a power cell 12 in such a three-phase power converter 1 with the flow of electric power being in a direction to supply power alone.

The power cell 12 of FIG. 11 has a first input terminal group 13 and a second input terminal group 30. The first input terminal group 13 is connected with a polyphase diode rectifier circuit 26a using phase modules 19a-19c, as shown in FIG. 12, whereas the second input terminal group 30 is connected with a polyphase diode rectifier circuit 26b using phase modules 19f-19h. Charging voltages for the three-level type filter capacitors 36a, 36b are kept in balance with each other by means of these two polyphase diode rectifier circuits 26a, 26b. What is to be considered in this case is harmonics in the first input terminal group 5. As shown in FIG. 13, an input transformer group 34 of the power unit 4 includes three input transformers 9a, 9b, 9c. The input transformers 9a, 9b, 9c are winding-type transformers each having a single primary winding 10a, 10b, 10c and a secondary winding pair 35a, 35b, 35c including a delta connection and a star connection. The secondary winding pairs 35a, 35b, 35c each comprises secondary windings 11a, 11c, 11e connected in a delta configuration, and secondary windings 11b, 11d, 11f connected in a star configuration. Each of the secondary windings is connected with a first input terminal group 13a, 13b, 13c and a second input terminal group 30a, 30b, 30c, mutually different from each other, of the corresponding power cells 12a, 12b, 12c. According to such a configuration, generations of harmonics on the primary windings 10a, 10b, 10c sides of the input transformers 9a, 9b, 9c become about 12 times corresponding to the number of switchings of the polyphase self-excited rectifier circuit 16. Therefore, it is possible to effectively suppress harmonics without using polyphase winding transformers of complex configurations as the input transformers 9a, 9b, 9c.

Such a power converter using input transformers each having the two secondary windings one with a star connection and the other with a delta connection can suppress harmonics in the primary windings of the input transformers.

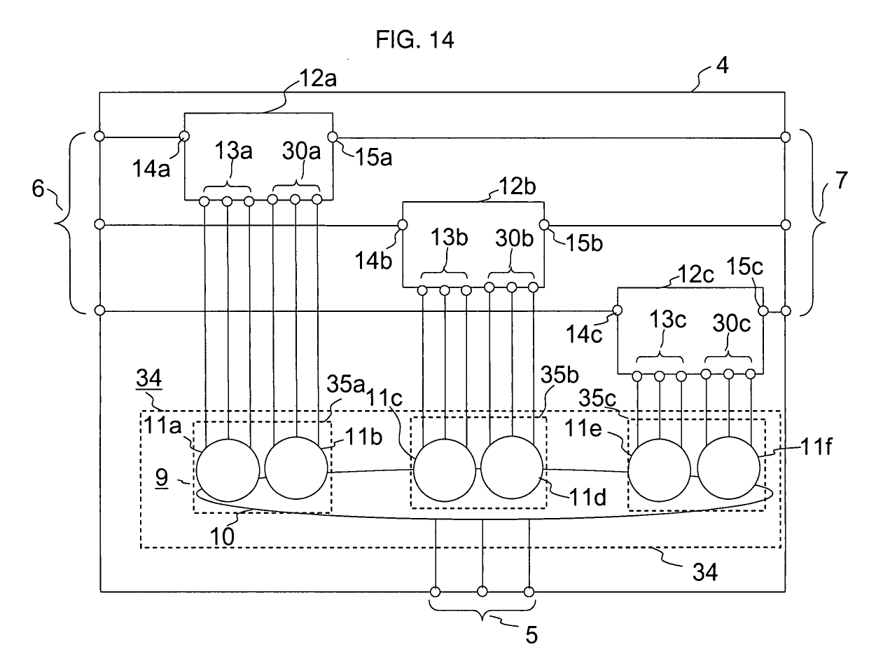

In addition, the input transformer group 34 may comprise, instead of the three input transformers, a single input transformer 9 having one primary winding 10 and three secondary winding pairs 35a, 35b, 35c, as shown in FIG. 14. In this case, the input transformer 9 may have one primary winding 10 and six secondary windings, while providing a similar advantageous effect.

Embodiment 6.

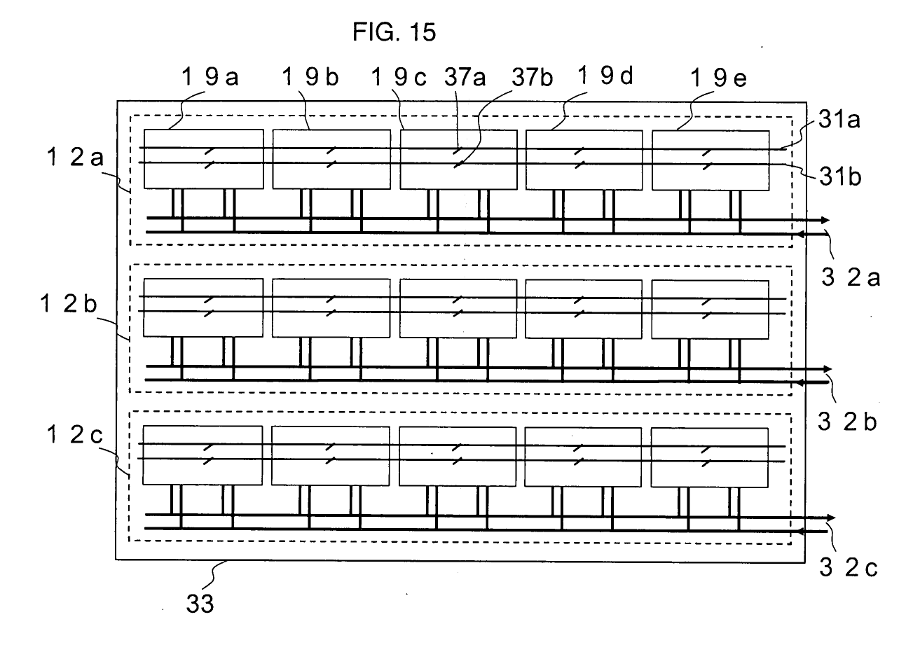

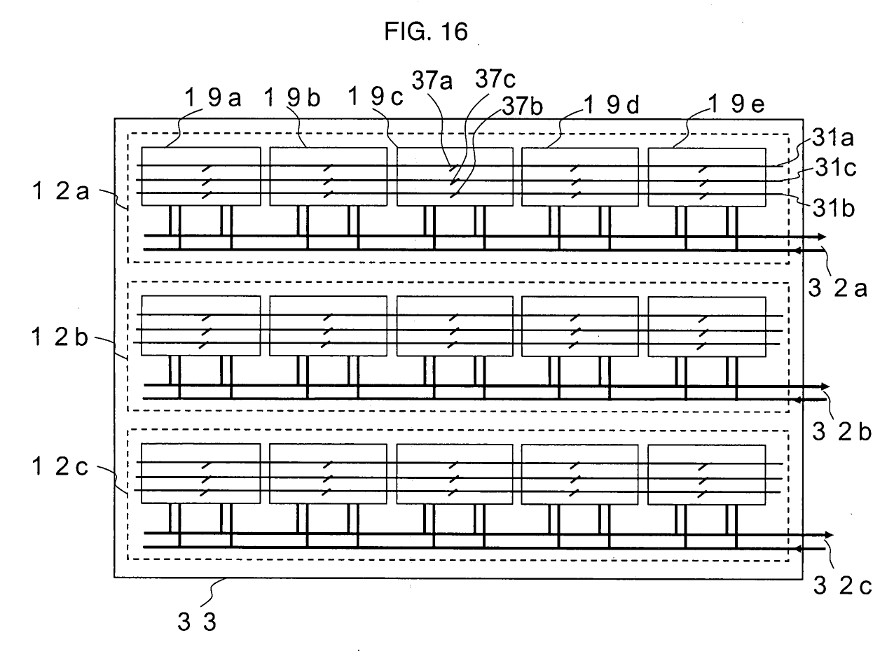

FIG. 15 shows the circuit configuration of power cells in a power converter according to a sixth embodiment of the present invention, and FIG. 16 shows the circuit configuration of power cells in a modified power converter according to a sixth embodiment of the present invention. In FIG. 15, the power cells similar to those shown in FIG. 4 are used, and hence an explanation of similar portions is omitted. In FIG. 16, the power cells similar to those shown in FIG. 8 are used.

As shown in FIG. 15, each of the power cells 12a-12c comprises five phase modules 19a-19e arranged horizontally in a line. Moreover, horizontally extending direct current buses 31a, 31b are connected with two terminals 37a, 37b of a DC link circuit 17 (see FIG. 4) common to the phase modules 19a-19e, so that they distribute potentials P, N to the phase modules 19a-19e, respectively. Further, it is necessary to cool the self-arc-extinguishing type semiconductor devices 23a, 23b and the diode 24a, 24b, which together constitute the phase module 19 as shown in FIG. 4, or other parts for which forced cooling is required, by using a cooling medium such as cooling water. At least inlet-side and outlet-side cooling headers 32a-32c through which the cooling medium is flowing are arranged in parallel to the direct current buses 31a, 31b so as to make common use of the cooling medium for the phase modules 19a-19e, whereby the cooling medium is distributed from the cooling headers 32a-32c to the respective phase modules 19a-19e. In addition, the power cell portions of the power unit 4, i.e., a power cell rack 33 of FIG. 2, is constructed by stacking the power cells 12a, 12b, 12c, for example, in three layers with insulating parts such as insulators for insulating line-to-line voltages being disposed between adjacent power cells. When five phase modules 19a-19e constituting each power cell 12a, 12b, 12c are horizontally arranged as shown in FIG. 15, the same insulation design is applicable to the electric members and the water-cooling members used for all the phase modules 19. For instance, the three-phase power converter 1 of FIG. 1 can be achieved by using four power cell racks 33 each shown in FIG. 15. It is preferable that a filter capacitor 36, which is a component of the DC link circuit 17, be arranged in parallel to the direct current buses 31a, 31b in such a manner as to form a distribution constant circuit for instance in order to reduce the influence of voltage oscillations due to the floating inductance of the direct current buses 31a, 31b.

In such a power converter; the directions in which the direct current buses and the cooling headers are extended are the same as the directions in which the plurality of phase modules are arranged, and hence an insulation reference of each power cell, which is composed of a plurality of phase modules, can be made as the voltage of each direct current bus, whereby the power cells can be reduced in size, thus making it possible to minimize the overall size of the power converter.

Here, note that in cases where the power cells 12a, 12b, 12c are of the three-level type as shown in FIG. 8, horizontally extending direct current buses 31a-31c are connected with three terminals 37a, 37b, 37c of a DC link circuit common to phase modules 19a-19e, as shown in FIG. 16, so that they distribute potentials P, C, N to the phase modules 19a-19e, respectively. In this connection, there is no difference in the arrangement, operation and resultant advantageous effect of cooling buses 32a-32c and filter capacitors of the DC link circuit (see the filter capacitors 36a, 36b of the DC link circuit 17 in FIG. 8) between the configurations of FIG. 15 and FIG. 16.

Embodiment 7.

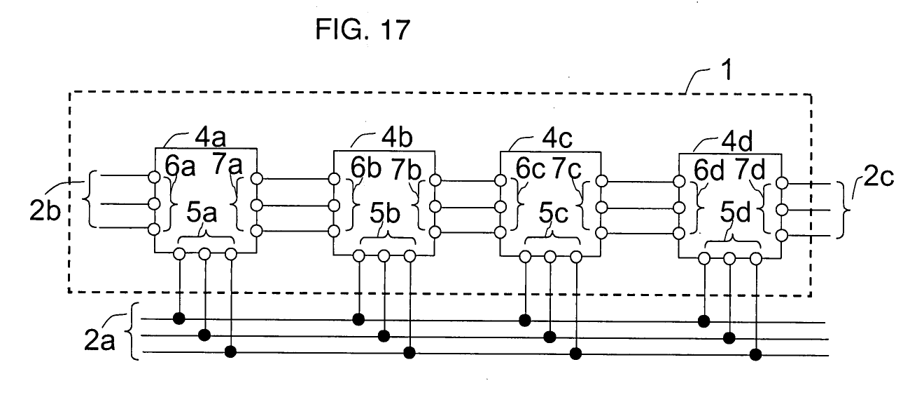

FIG. 17 shows the circuit configuration of a power converter according to a seventh embodiment of the present invention, in which power units employed therein are similar to those of FIG. 1, thus omitting an explanation of similar portions.

The three-phase power converter, generally designated at reference numeral 1, are constructed such that a first power unit 4a has a first output terminal group 6a connected with a second polyphase AC power supply 2b, and a fourth power unit 4d has a second output terminal group 7d connected with a third polyphase AC power supply 2c. In addition first through fourth power units 4a-4h have their respective first input terminal groups 5a-5h all connected with a polyphase AC power supply 2a. With such connections, it becomes possible to control power interchange or tidal current between the second polyphase AC power supply 2b and the third polyphase AC power supply 2c by means of the three-phase power converter 1. In this control, necessary electric power can be received from the first polyphase AC power supply 2a.

In addition, if such performance is enhanced, it will be possible to achieve power interchange among the first polyphase AC power supply 2a, the second polyphase AC power supply 2b and the third polyphase AC power supplies 2c. Moreover, a relatively great amount of effective power is needed to compensate for a voltage variation in the second polyphase AC power supply 2b or the third polyphase AC power supply 2c, or to suppress an overcurrent that is caused to flow due to an accident of these power supplies. In this case, obtaining effective electric power from the first polyphase AC power supply 2a eliminates the need for providing a constraint for the period in which a voltage variation can be compensated or for the period in which an overcurrent can be suppressed. In this connection, it should be noted that in order to achieve the same function as stated above when the second and third polyphase AC power supplies 2b, 2c are not connected with the first polyphase AC power supply 2a through the power converter 1, it is necessary to limit the compensation or suppression period due to an increase in the electrostatic capacity of a filter capacitor in each power cell (confer the filter capacitor 36 in the power cell 12 in FIG. 4).

Such a power converter is constructed from a plurality of the same power units, and hence a voltage difference between the first polyphase AC power supply 2a and the second or third polyphase AC power supply 2b or 2c can be accommodated merely by changing the number of the power units used. Accordingly, there is no need to change the input transformer or the like, thus making it possible to enhance the reliability of the power converter. Furthermore, since power interchange between the first polyphase AC power supply 2a and the second and third polyphase AC power supplies 2b, 2c becomes possible, the stability of the entire polyphase AC power supplies can be improved.

Embodiment 8.

A power converter according to an eighth embodiment of the present invention is different from the above-mentioned embodiments 1 through 7 only in that it is connected with a turbogenerator group 38, as shown in FIG. 1, but it is similar to them in the other respects and hence an explanation of similar portions is omitted.

When the voltage of a polyphase AC power supply 2 in such a three-phase power converter 1 is maintained by the turbogenerator group 38, it is possible to maintain the power factor of the power supply at a value higher when a three-phase self-excited rectifier circuit 16 is used than when a diode rectifier circuit is used. As a result, in case where a new turbogenerator is introduced, the turbogenerator with a low rated capacity can be applied.

On the other hand, in the case of an existing turbogenerator, the operating condition of the turbogenerator can be set to a power output that is lower than the rating, and hence there is provided an advantageous effect that more reliable operation can be expected.

Embodiment 9.

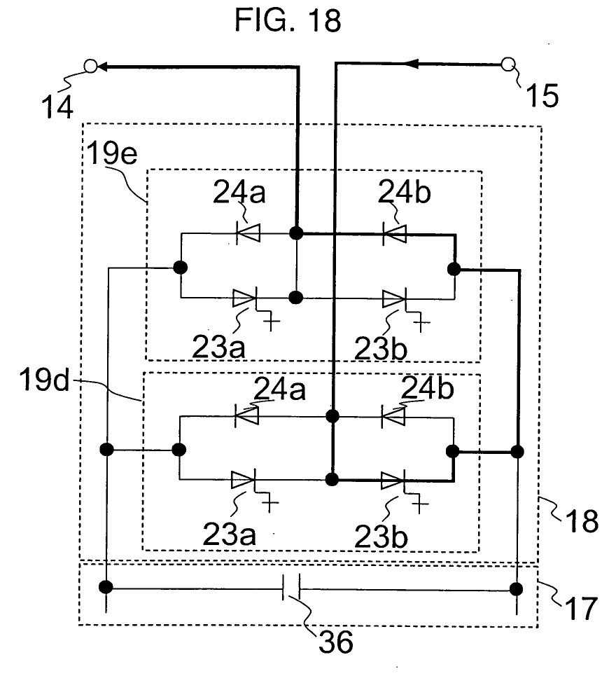

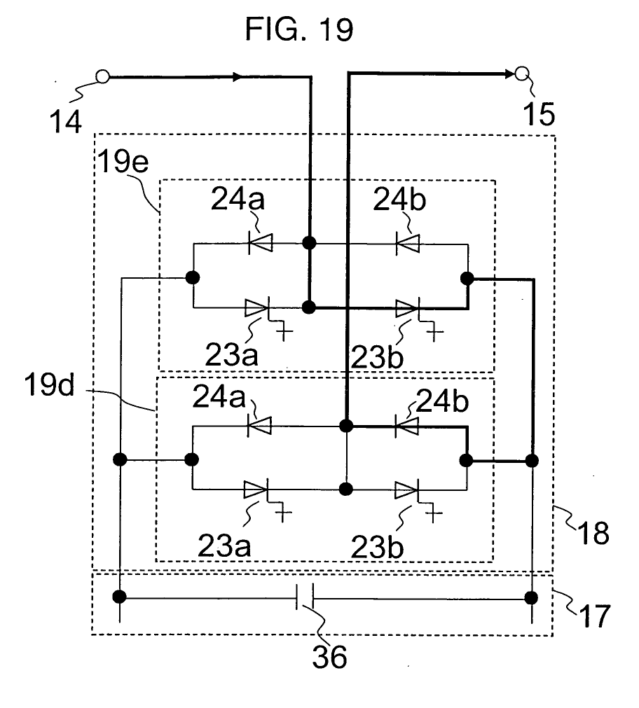

FIG. 18 shows a power unit protective device in a power converter according to a ninth embodiment of the present invention, and FIG. 19 is a view similar to FIG. 18 but shows that a self-arc-extinguishing type semiconductor device of a phase module is in a failure. A power cell in this embodiment differs from that of FIG. 3 only in the provision of the protective device but is similar thereto in the other respects and hence an explanation of the similar portions is omitted.

Now, reference will be made to the operation of the protective device when a failure occurs in a single-phase self-excited inverter circuit 18 in a power cell 12a in a power unit 4a among serially connected power units 4a-4d of a three-phase power converter 1 (confer FIG. 2). In FIG. 18, there are shown phase modules 19d, 19e of the power cell 12 in FIG. 4. When a self-arc-extinguishing type semiconductor device 23b of the phase module 19e of the single-phase self-excited inverter circuit 18 has failed, a self-arc-extinguishing type semiconductor device 23b of another normally operating phase module 19d, which is arranged at the same location as the failed self-arc-extinguishing type semiconductor device 23b of the phase module 19e is, is forcedly fired and the other self-arc-extinguishing type semiconductor device 23a in the phase module 19d is forcedly extinguished. Thus, the switching state of the normally operating phase module 19d is forcedly fixed by turning on and off the self-arc-extinguishing type semiconductor devices 23b, 23a, respectively, whereby it is possible to ensure a route for a bidirectional electric current to bypass a DC link circuit 17, as indicated by the solid line in FIG. 18, as a result of which the failed power cell 12a can be protected from an overvoltage which might otherwise be applied to the failed power cell 12a.

Similarly, when the self-arc-extinguishing type semiconductor device 23b of the phase module 19d of the single-phase self-excited inverter circuit 18 has failed, as shown in FIG. 19, a self-arc-extinguishing type semiconductor device 23b of another normally operating phase module 19e, which is arranged at the same location as the failed self-arc-extinguishing type semiconductor device 23b of the phase module 19d is, is forcedly fired and the other self-arc-extinguishing type semiconductor device 23a in the phase module 19d is forcedly extinguished, whereby the failed power cell 12a can be protected from an overvoltage, as in the previous case.

In addition, when one fuse is connected with a P terminal or an N terminal of each of the phase modules 19d, 19e, all the self-arc-extinguishing type semiconductor devices 23a, 23b having no fuse are forcedly fired and the other self-arc-extinguishing type semiconductor devices 23b, 23a are forcedly extinguished, whereby it is possible to ensure routes for bidirectional electric currents to bypass the DC link circuit 17, as shown in FIGS. 18 and 19. Consequently, the failed power cell 12a can be protected from an overvoltage which might otherwise be applied to the failed power cell 12a.

In other words, either one of the self-arc-extinguishing type semiconductor devices 23a, 23b of each of the phase modules 19d, 19e is forcedly fired and the other thereof is forcedly extinguished, as shown in FIG. 18 or in FIG. 19. As a result, it is possible to ensure a current path for bypassing the electric current of the failed power cell 12a without passing through a filter capacitor 36 therein, so that such a failure can be prevented from being extended to the other normally operating power units 4b-4d constituting the three-phase power converter 1.

With such a power converter, electric current flowing into a failed power cell can be bypassed without passing through the filter capacitor of the failed power cell by forcedly firing a certain selected self-arc-extinguishing type semiconductor device. Accordingly, the output voltage of the failed power cell can be reduced to a very small voltage which is determined by the on voltages of the self-arc-extinguishing type semiconductor device and the diode of the failed power cell, as compared with the charging voltage of the filter capacitor. As a consequence, it is possible to continue the operation of the power converter though the rated capacity thereof is decreased.

Embodiment 10.

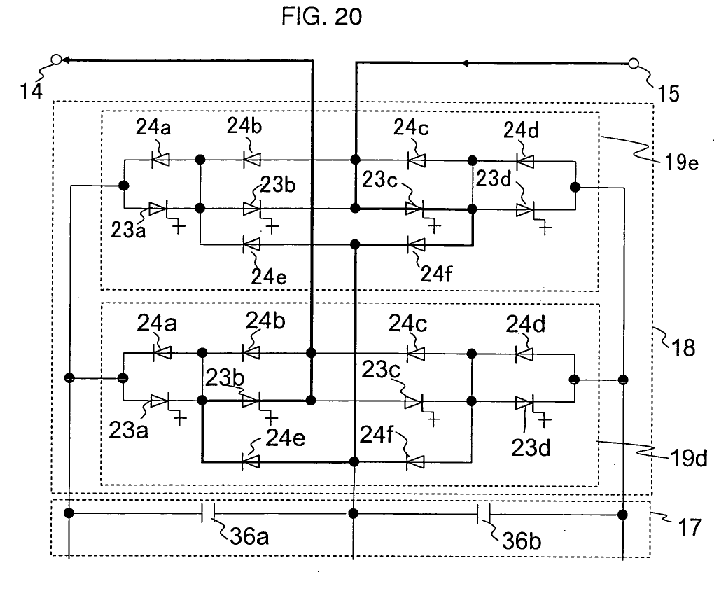

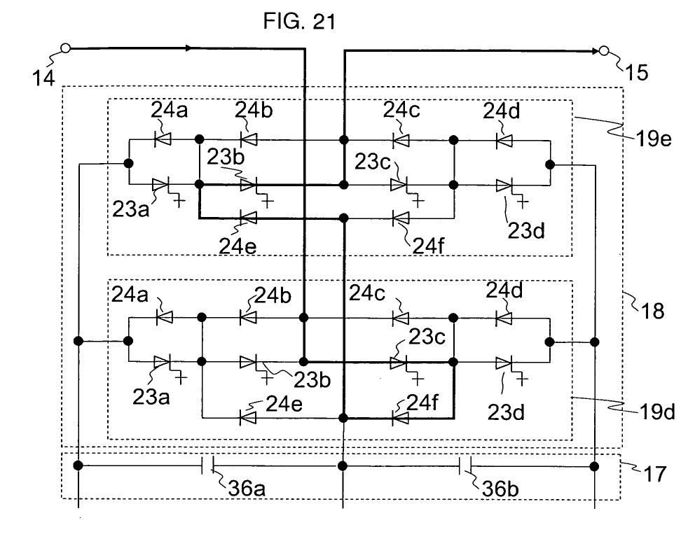

A tenth embodiment of the present invention relates to a protective method for protecting a three-phase power converter 1 when a failure occurs, for example, in a single-phase self-excited inverter circuit 18 in a power cell 12a (confer FIG. 2) in a power unit 4a among serially connected power units 4a-4d in FIG. 1. In FIGS. 20 and 21, there are shown phase modules 19d, 19e of the power cell 12 in FIG. 8. When a self-arc-extinguishing type semiconductor device 23b of the phase module 19e constituting the single-phase self-excited inverter circuit 18 has failed, a self-arc-extinguishing type semiconductor device 23c, which is connected in series with the failed self-arc-extinguishing type semiconductor device 23b, and mutually serially connected self-arc-extinguishing type semiconductor devices 23b, 23c of another normally operating phase module 19d are all forcedly fired or turned on, and at the same time self-arc-extinguishing type semiconductor devices 23a, 23d of the failed phase module 19e and self-arc-extinguishing type semiconductor devices 23a, 23d of the normally operating phase module 19d are all forcedly extinguished or turned off, whereby it is possible to ensure routes for bidirectional electric currents to bypass a DC link circuit 17, as indicated by solid lines in FIGS. 20 and 21, as a result of which the failed power cell 12a can be protected from an overvoltage which might otherwise be applied to the failed power cell 12a. In addition, when the self-arc-extinguishing type semiconductor device 23a of the phase module 19e has failed, the self-arc-extinguishing type semiconductor devices 23a, 23b of the phase module 19d are forcedly fired. Moreover, when the self-arc-extinguishing type semiconductor device 23b of the phase module 19e has failed, the self-arc-extinguishing type semiconductor devices 23b, 23c of the failed phase module 19d are forcedly fired. Further, when the self-arc-extinguishing type semiconductor device 23c of the phase module 19e has failed, the self-arc-extinguishing type semiconductor devices 23b, 23c of the phase module 19d are forcedly fired. Furthermore, when the self-arc-extinguishing type semiconductor device 23d of the phase module 19e has failed, the self-arc-extinguishing type semiconductor devices 23c, 23d of the phase module 19d are forcedly fired or turned on. In this manner, the power converter can be protected against any type of failures in the self-arc-extinguishing type semiconductor devices 23a-23d.

In addition, when two fuses are connected with a P terminal and an N terminal, respectively, of each of the phase modules 19d, 19e, all the self-arc-extinguishing type semiconductor devices 23b, 23c are forcedly fired or turned on and at the same time all the other self-arc-extinguishing type semiconductor devices 23a, 23d are forcedly extinguished or turned off, whereby it is possible to ensure routes for bidirectional electric currents to bypass a DC link circuit 17, as indicated by the solid lines in FIGS. 20 and 21, as a result of which the failed power cell 12a can be protected from an overvoltage which might otherwise be applied to the failed power cell 12a.

In other words, either those two of the self-arc-extinguishing type semiconductor devices 23a-23d of each of the phase modules 19d, 19e which are in a serially connected relation with each other are forcedly fired and the others thereof are forcedly extinguished, as shown in FIG. 20 or in FIG. 21. As a result, it is possible to ensure bypass routes for bidirectional electric currents flowing through a failed power cell 12a without passing through the filter capacitors 36a, 36b therein, so that such a failure can be prevented from being extended to the other normally operating power units 4b-4d constituting the three-phase power converter 1.

Embodiment 11.

The circuit configurations of phase modules 19 (i.e., 19a-19e) used in the three-phase self-excited rectifier circuit 16 and the single-phase self-excited inverter circuit 18 of the power cell 12 in FIG. 4 or in FIG. 8 are all the same, and hence it is necessary to make the voltage ratings of the self-arc-extinguishing type semiconductor devices 23a-23d and the diodes 24a-24f used for all the phase modules 19 (see FIG. 9) equal to one another.

In a power converter according to an eleventh embodiment of the present invention, the voltage ratings of the self-arc-extinguishing type semiconductor devices 23a-23d and the diodes 24a-24f of the phase modules 19 (19a-19e) used in the three-phase self-excited rectifier circuit 16 are less than the voltage ratings of the self-arc-extinguishing type semiconductor devices 23a-23d and the diodes 24a-24f of the phase modules 19 (19a-19e) used in the single-phase self-excited inverter circuit 18. By so doing, it is possible to improve the electric current utilization factors of the self-arc-extinguishing type semiconductor devices 23a-23d and the diodes 24a-24f of the three-phase self-excited rectifier circuit 16. This is because the number of phase modules 19 used in the three-phase self-excited rectifier circuit 16 is set to three, whereas the number of phase modules 19 used in the single-phase self-excited inverter circuit 18 is set to two.

In this eleventh embodiment, the self-arc-extinguishing type semiconductor devices 23a-23d and the diodes 24a-24f with the same voltage ratings but different current ratings are used for this purpose.

In this connection, it is to be noted that such a purpose can be achieved by using a different number of self-arc-extinguishing type semiconductor devices 23a-23d and a different number of diodes 24a-24f both of the same voltage ratings and the same current ratings connected in parallel with one another.

Since such a power converter can improve the current utilization factor of each phase module, it is possible to fabricate the phase modules used for the three-phase self-excited rectifier circuits at low cost. Accordingly, the manufacturing cost of the power converter can be reduced.

Embodiment 12.

The power converter according to the above-mentioned eleventh embodiment uses the phase modules 19 having the same voltage ratings but different current ratings. For instance, for the phase modules 19 as shown in FIG. 9, there are used phase modules of a small current rating and those of a large current rating. Now, reference will be made to the power cell 12 shown in FIG. 8 which is constructed by using these two kinds of phase modules in accordance with a twelfth embodiment of the present invention. First, let us assume as follows: that is, the single-phase passable output capacity and the three-phase passable input capacity of the power cell 12 are X1 and Y1, respectively, when phase modules of a small current rating are used for the phase modules 19a-19e; the single-phase passable output capacity and the three-phase passable input capacity of the power cell 12 shown in FIG. 8 are X2 and Y2, respectively, when phase modules of a large current rating are used for the phase modules 19a 19c constituting the power cell 12; the single-phase passable output capacity and the three-phase passable input capacity of the power cell 12 shown in FIG. 8 are X1 and Y2, respectively, when phase modules of a small current rating are used for the phase modules 19a-19c of the power cell 12 and when phase modules of a large current rating are used for the phase modules 19d and 19e of the power cell 12; and the single-phase passable output capacity and the three-phase passable input capacity of the power cell 12 shown in FIG. 8 are X2 and Y1, respectively, when phase modules Of a large current rating are used for the phase modules 19a-19c constituting the power cell 12 and when phase modules of a small current rating are used for the phase module 19d and 19e of the power cell 12. In this manner, power cells 12 having four kinds of input passable output capacities can be constructed. In other words, even in case where the number of power units 4 in a three-phase power converter 1 is one, four kinds of three-phase power converters 1 can be provided.

When an application of the present invention as shown in the above-mentioned eleventh embodiment is considered, a power capacity necessary to stabilize a pqlyphase AC power supply varies according to the capacity and the voltage control performance of a turbogenerator. If the passable input capacity of a power unit 4 can be varied, optimal power cells 12 thereof can be selected according to the stability of the power unit 4.

In addition, when the number of power units is two, as shown in FIG. 10, a total of nine kinds of (input and output) configurations comprising (2X1, 2Y1), (2X1, 2Y2), (2X1, Y1+Y2), (2X2, 2Y1), (2X2, 2Y2), (2X2, Y1+Y2), (X1+X2, 2Y1), (X1+X2, 2Y2) and (X1+X2, Y1+Y2) can be formed as passable input and output capacities. In other words, when the number of power units 4 of the three-phase power converter 1 is two, nine kinds of three-phase power converters 1 can be achieved.

Since three-phase power converters 1 with much more variety of capacities can be constructed by increasing the number of power units 4 in this manner, it is possible to provide optimal three-phase power converters 1 for polyphase AC loads 3 of various ratings or polyphase AC power supplies 2 of various stabilities.

Moreover, by combining power units of different output capacities with one another, a polyphase AC power supply can have much more various passable input capacities as well as much more various passable output capacities.

Further, although three or more phase modules of different current ratings can be used, the explanation herein has been made using phase modules with two different, large and small, current ratings while keeping in mind the use of a smallest possible number of standard phase modules 19.

Here, note that the above explanation has been made with such a configuration of the input transformer group that the number of secondary windings of an input transformer is one, two, three and six with respect to one primary winding, but the number of primary windings and the number of secondary windings are not limited to such combinations but can be increased according to the power capacity as required, while providing similar advantageous effects. Furthermore, although the number of input transformers has been explained as being one or three, it is possible to increase such a number according to the power capacity as required, as in the case of the number of windings.

As described above, according to the present invention, there is provided a power converter including a plurality of power units, each of which comprises: an input transformer group including at least one input transformer having at least one primary winding connected with a first polyphase AC power supply and at least one secondary winding; a polyphase self-excited rectifier circuit connected with the secondary winding; and a single-phase self-excited inverter circuit connected with the polyphase self-excited rectifier circuit through a DC link circuit to generate a single-phase power output. Adjacent ones of the power units in each phase are sequentially cascaded in series with one another, with one of the power units at one end of the cascade connection being connected with a polyphase AC load, another one of the power units at the other end of the cascade connection being connected with a neutral point, whereby electric power is input from the first polyphase AC power supply to the power units and output therefrom to the polyphase AC load, or the electric power of the polyphase AC load is regenerated to the first polyphase AC power supply. With such a construction, a change in the required voltage of the polyphase AC load can be accommodated merely by changing the number of the power units used. Accordingly, there is no need to change the input transformer or the like, thus making it possible to enhance the reliability of the power converter.

While the invention has been described in terms of preferred embodiments, those skilled in the art will recognize that the invention can be practiced with modifications within the spirit and scope of the appended claims.

1. A power converter including a plurality of power units, each of said power units comprising:
an input transformer group including at least one input transformer having at least one primary winding connected with a first polyphase AC power supply, and at least one secondary winding;
a polyphase self-excited rectifier circuit connected with said secondary winding;
a single-phase self-excited inverter circuit; and
a DC link circuit connecting said single-phase self-excited rectifier circuit to said polyphase self-excited rectifier circuit to generate a single-phase power output, wherein mutually adjacent ones of said power units in each phase are sequentially cascaded in series with one another, with one of said power units at a first end of a cascade connection being connected with a polyphase AC load, another one of said power units at a second end of the cascade connection being connected with a neutral point, whereby electric power is input from said first polyphase AC power supply to said power units and output from said power units to said polyphase AC load, or the electric power of said polyphase AC load is regenerated to said first polyphase AC power supply.

2. The power converter as set forth in claim 1, wherein said polyphase self-excited rectifier circuit includes mutually parallel-connected phase modules corresponding in number to the number of phases of said first polyphase AC power supply, and said single-phase self-excited inverter circuit includes two phase modules.

3. The power converter as set forth in claim 2, wherein said phase module includes self-arc-extinguishing semiconductor devices.

4. The power converter as set forth in claim 2, wherein said phase modules of said single-phase self-excited inverter circuit have a current rating greater than that of said phase modules of said polyphase self-excited rectifier circuit.

5. The power converter as set forth in claim 1, wherein said DC link circuit includes a filter capacitor having opposite terminals charged at different potentials, and said single-phase self-excited inverter circuit selectively outputs one of the potentials in a single phase.

6. The power converter as set forth in claim 1, wherein said DC link circuit includes filter capacitors connected in series with one another and having three terminals charged at different potentials, and said single-phase self-excited inverter circuit selectively outputs one of the potentials in a single phase.

7. The power converter as set forth in claim 1, wherein said input transformer group includes an input transformer having one primary winding and secondary windings corresponding in number to the number of phases of said polyphase AC load.

8. The power converter as set forth in claim 1, wherein said input transformer group includes input transformers corresponding in number to the number of phases of said polyphase AC load, each of said input transformers having one primary winding and one secondary winding.

9. The power converter as set forth in claim 6, wherein said input transformer group includes input transformers corresponding in number to the number of phases of said polyphase AC load, each of said input transformers having one primary winding and at least one pair of secondary windings comprising a star connection and a delta connection, and said polyphase self-excited rectifier circuit includes two polyphase diode rectifier circuits which are connected in parallel to said filter capacitors, respectively, of said DC link circuit, and connected with said star connection and said delta connection, respectively, of said paired secondary windings.

10. The power converter as set forth in claim 6, wherein said input transformer group includes one input transformer having one primary winding and a plurality of pairs of secondary windings corresponding in number to the phases of said first polyphase AC load, each pair of said secondary windings comprising a star connection and a delta connection, and said polyphase self-excited rectifier circuit includes two polyphase diode rectifier circuits which are connected in parallel to said filter capacitors, respectively, of said DC link circuit, and connected with said star connection and said delta connection, respectively, of said paired secondary windings.

11. The power converter as set forth in claim 1, wherein said at least one power unit has a passable input capacity different from that of others of said power units.

12. The power converter as set forth in claim 1, wherein said at least one power unit has a passable output capacity different from that of others of said power units.

13. The power converter as set forth in claim 1, wherein said power units arranged at opposite ends of the cascade connection are connected with second and third, polyphase AC power supplies, other than said first polyphase AC power supply, so that electric power is input from said first polyphase AC power supply to said power units and output to said second and third polyphase AC power supplies, or the electric power from said second and third polyphase AC power supplies is reversely supplied to said first polyphase AC power supply.

14. The power converter as set forth in claim 1, wherein said plurality of power units are divided into a plurality of groups, and in each group mutually adjacent power units in each phase are sequentially cascaded in series with one another, and one of said power units at a first end of the cascade connection is connected with said polyphase AC load, and another one of said power units at a second end of the cascade connection is connected with said neutral point, or said power units at the opposite ends are respectively connected with, second and third polyphase AC power supplies, other than said first polyphase AC power supply.

15. The power converter as set forth in claim 1, wherein each of said power units includes a plurality of power cells, each power cell having a phase module, and said DC link circuit includes a filter capacitor having opposite terminals charged at different potentials, said phase module including a plurality of direct current buses at different potentials, which are connected with said filter capacitor, and a cooling header, which is arranged in parallel to said direct current buses for guiding a cooling medium to flow therethrough.

16. The power converter as set forth in claim 5, wherein each of said power units includes a plurality of power cells, each power cell having a phase module, and when an abnormality occurs in said phase module, said single phase self-excited inverter circuit forcedly fixes switching state of said phase module to inhibit an electric current from flowing into said filter capacitor of said DC link circuit.

17. The power converter as set forth in claim 1, wherein said first polyphase AC power supply includes a turbogenerator group including a plurality of turbogenerators, and said polyphase AC load comprises an electric motor for driving a compressor.

18. The power converter as set forth in claim 1, wherein said DC link circuit includes a filter capacitor having opposite terminals charged at different potentials, and the poly-phase self-excited rectifier circuit adjusts the input power factor thereof so that the potential of the opposite terminals can be controlled.

19. The power converter as set forth in claim 1, wherein said DC link circuit includes filter capacitors connected in series with one another and having three terminals charged at different potentials, and the poly-phase self-excited rectifier circuit adjusts the input power factor thereof so that the potentials of the three terminals can be controlled.
